(19) United States
(12) Patent Application Publication
(10) Pub. No.: US 2019/0213282 A1
(43) Pub. Date: Jul. 11, 2019

(54) SYSTEMS AND METHODS FOR DETERMINING AWARENESS OF AN ENTITY ON A SOCIAL NETWORKING SYSTEM

(71) Applicant: Facebook, Inc., Menlo Park, CA (US)

(72) Inventors: Subramoniam Perumal, Mountain View, CA (US); Daniel Dinu, Sunnyvale, CA (US)

(21) Appl. No.: 15/868,930

(22) Filed: Jan. 11, 2018

(51) Int. Cl. G06F 17/30

(52) U.S. Cl. CPC G06F 17/30867; G06F 17/30554; G06F 17/3053

(57) ABSTRACT

Systems, methods, and non-transitory computer readable media are configured to receive a specification of an entity having a presence via an online channel. One or more scores based on one or more occurrences relating to the presence of the entity can be generated. The occurrences can relate to at least one of impressions or engagements by users in relation to the presence of the entity. Subsequently, one or more of the scores can be presented.

### FIELD OF THE INVENTION

The present technology relates to the field of computerized social networking systems. More particularly, the present technology relates to techniques for generating scores and metrics for entities relating to awareness within computerized social networking systems.

### BACKGROUND

A social networking system can be used for a wide variety of purposes. For example, an entity can use a page or other presence on the social networking system to connect with users of the social networking system. As an illustration, the entity can be a business, and the users can be customers of the business. The entity and the users can connect in a number of ways. As an example, the users can view posts made by the entity. As another example, the users and the entity can exchange messages with one another. As a further example, the users can view search results relating to the entity.

### SUMMARY

Various embodiments of the present disclosure can include systems, methods, and non-transitory computer readable media configured to receive a specification of an entity having a presence via an online channel. One or more scores based on one or more occurrences relating to the presence of the entity can be generated. The occurrences can relate to at least one of impressions or engagements by users in relation to the presence of the entity. Subsequently, one or more of the scores can be presented.

In an embodiment, the generating of the one or more scores can be further based on a query time.

In an embodiment, the generating of the one or more scores can comprise determining one or more levels for one or more of the occurrences.

In an embodiment, the generating of the one or more scores can comprise determining one or more decayed levels for one or more of the occurrences based on a query time and on one or more times of the one or more occurrences.

In an embodiment, the one or more scores can include one or more of an impression score, an engagement score, or an awareness score.

In an embodiment, a specification of a query time can be received.

In an embodiment, the online channel can be a page on a social networking system or messaging system.

In an embodiment, the one or more occurrences can be associated with one or more of viewing, liking, posting, following, or messaging.

In an embodiment, one or more metrics for one or more of the scores can be generated.

In an embodiment, the one or more metrics can include one or more of a top categories metric, a fan versus not fan metric, or a new versus returning users metric.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example awareness module, according to an embodiment of the present disclosure.

FIG. 2 illustrates an example analysis module, according to an embodiment of the present disclosure.

FIG. 3 illustrates an example report module, according to an embodiment of the present disclosure.

FIG. 4 illustrates an example interface, according to an embodiment of the present disclosure.

FIG. 5 illustrates an example process, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Determining Awareness of an Entity on a Social Networking System

A social networking system can be used for a wide variety of purposes. For example, an entity can use a page or other presence on the social networking system to connect with users of the social networking system. As an illustration, the entity can be a business, and the users can be customers of the business. The entity and the users can connect in a number of ways. As an example, the users can view posts made by the entity to the page. As another example, the users and the entity can exchange messages with one another. As a further example, the users can view search results relating to the entity.

A page can have an administrator. The administrator can take various actions which relate to the page. For example, the administrator can change a frequency with which the entity creates posts or exchanges messages with users of the social networking system. As another example, the administrator can make content changes to the posts or to the messages. As a further example, the administrator can make changes to the page which can affect search results in which the page can potentially appear. These actions taken by the administrator can impact impressions and engagements between the users of the social networking system and the page. However, conventional approaches typically do not adequately aid the administrator in understanding how their actions impact impressions or engagements between the users and the page. For example, some conventional approaches can use a number of fans which a page has to estimate impressions or engagements for the page. However, a user can like a page but then subsequently not visit the page. Thus, a number of fans which a page has can overapproximate impressions and engagements for the page. Further, impressions and engagements can occur between a page and users who have not liked the page. However, such users are not reflected in a number of fans which the page has.

Due to these or other concerns, the aforementioned and other conventional approaches specifically arising in the realm of computer technology can be disadvantageous or problematic. Therefore, an improved approach can be beneficial for addressing or alleviating various drawbacks associated with conventional approaches. Based on computer technology, the disclosed technology can generate scores for a business or other entity which has a page or other presence on a social networking system. The scores can quantify various occurrences relating to, for example, impressions or engagements by users in relation to the page or other presence. The scores can measure a quantity of impressions or engagements by the users. The disclosed technology can also generate various metrics for a score. The metrics can provide detail relating to a breakdown of categories of various users and occurrences which contribute to the score. The disclosed technology can further present the scores and metrics to a user who administrates the page or other presence so that the user can take action to optimize performance of the page or presence. In some embodiments, the scores can be used in ranking items for possible inclusion in feeds of users. Further, in some embodiments, the scores can be used in identifying trending pages. More details regarding the discussed technology are provided herein.

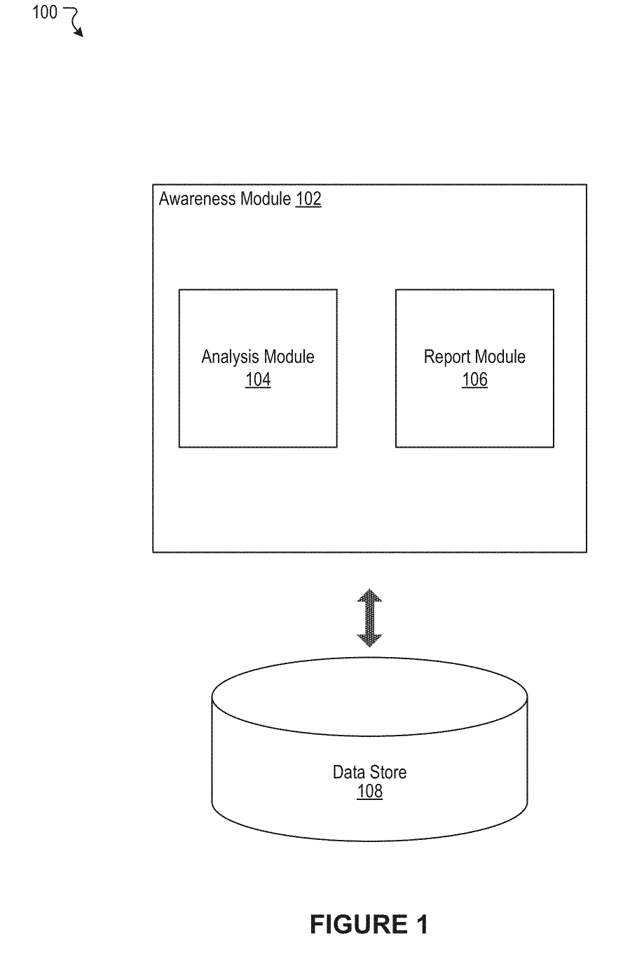

FIG. 1 illustrates an example system 100 including an example awareness module 102, according to an embodiment of the present disclosure. The awareness module 102 can determine an awareness score that measures an “awareness” relating to a page or other presence of an entity on a platform, such as a social networking system or a messaging system. As used herein, an entity can include any type of entity, such as a business, company, brand, service, product, public figure, individual, etc. An administrator of a page or other presence of an entity can use the awareness score to, for example, implement or revise online campaigns to improve user awareness of their page or presence. The entity can have a presence through one or more online channels. As an example, a channel can be a page (or other location) on a social networking system, messaging supported by a messaging system through which the entity can provide information, or other online medium through which the entity can communicate with others. Although a page is sometimes referenced in relation to an entity in various examples discussed herein, the present disclosure applies equally to any other type of presence of the entity or channel through which the entity can communicate. As shown in the example of FIG. 1, the awareness module 102 can include an analysis module 104 and a report module 106. In some instances, the example system 100 can include at least one data store 108. The components (e.g., modules, elements, etc.) shown in this figure and all figures herein are exemplary only, and other implementations can include additional, fewer, integrated, or different components. Some components may not be shown so as not to obscure relevant details. In some embodiments, the awareness module 102 can be implemented in a system, such as a social networking system. While the disclosed technology may be described herein in connection with a social networking system for illustrative purposes, the disclosed technology can be implemented in any other type of system or environment.

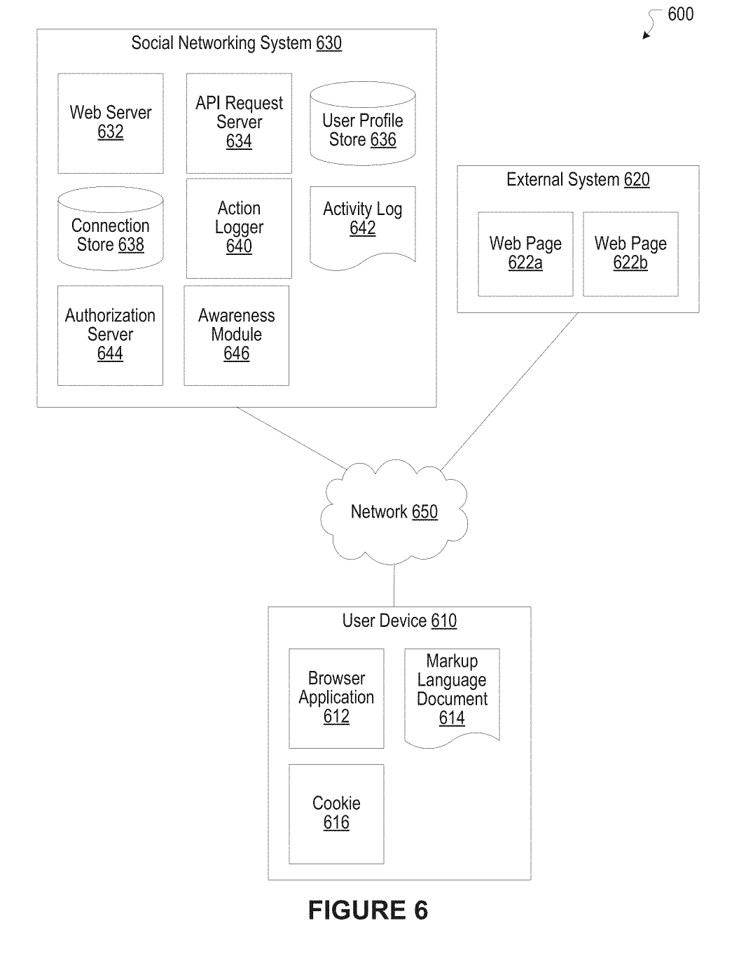

In some embodiments, the awareness module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the awareness module 102 can be implemented, in part or in whole, as software running on one or more computing devices or systems. For example, the awareness module 102 or at least a portion thereof can be implemented using one or more computing devices or systems that include one or more servers, such as network servers or cloud servers. In another example, the awareness module 102 or at least a portion thereof can be implemented as or within an application (e.g., app), a program, an applet, or an operating system, etc., running on a user computing device or a client computing system, such as a user device 610 of FIG. 6. In some instances, the awareness module 102 can, in part or in whole, be implemented within or configured to operate in conjunction with a system (or service), such as a social networking system 630 of FIG. 6. The application incorporating or implementing instructions for performing functionality of the awareness module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that there can be many variations or other possibilities.

The awareness module 102 can be configured to communicate and/or operate with the at least one data store 108, as shown in the example system 100. The at least one data store 108 can be configured to store and maintain various types of data. For example, the data store 108 can store information used or generated by the awareness module 102. The information used or generated by the awareness module 102 can include, for example, log data, score data, and metrics data. In some implementations, the at least one data store 108 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 108 can store information associated with users, such as user identifiers, user information, profile information, user specified settings, content produced or posted by users, and various other types of user data.

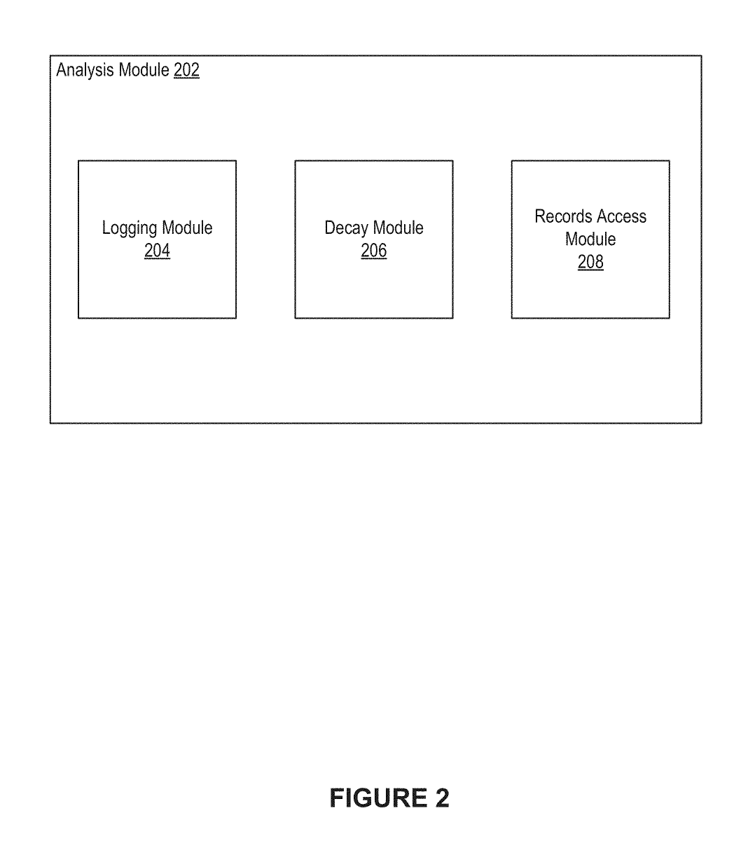

The analysis module 104 can detect that an occurrence has taken place in relation to an entity. An occurrence can be, for example, an impression, engagement (e.g., liking, commenting, sharing, etc.), or other action taken by a user that relates to a page of an entity on a social networking system. The analysis module 104 can also generate a record of the occurrence. Based on records of occurrences, the analysis module 104 can be used to facilitate generation of scores and metrics relating to an awareness associated with the page, as discussed below. Additional details regarding the analysis module 104 are provided below with reference to FIG. 2.

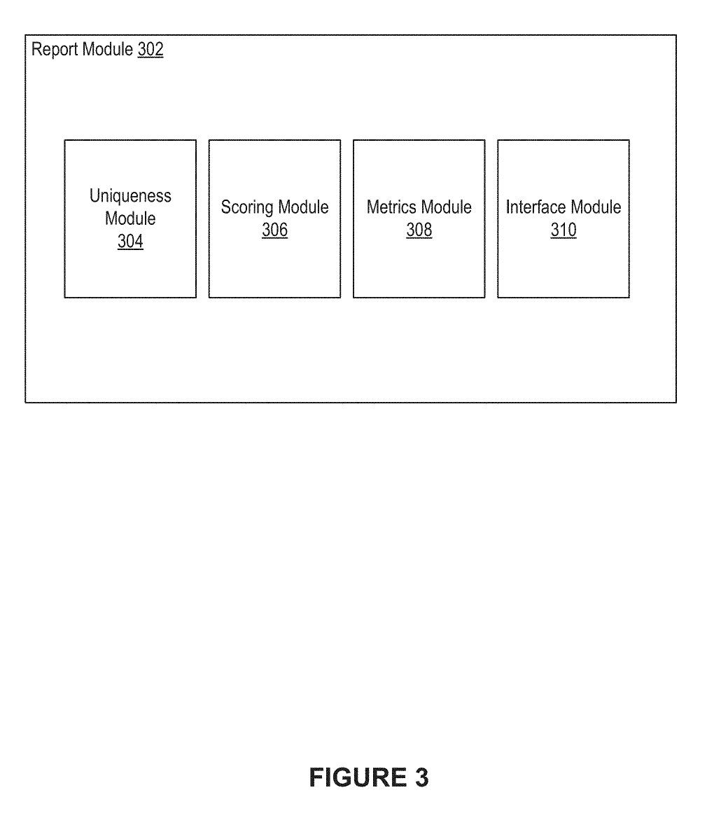

The report module 106 can generate scores and metrics for an entity which has a page on a social networking system. The scores can quantify occurrences, such as those discussed above. The report module 106 can also generate for a metric for a score which can provide further detail relating to the score. As just one example, a metric can be generated which specifies how many new and how many returning users contributed to the score. The scores and metrics can be subsequently presented by the report module 106 to a user who is an administrator for the page. Additional details regarding the report module 106 are provided below with reference to FIG. 3.

FIG. 2 illustrates an example analysis module 202, according to an embodiment of the present disclosure. In some embodiments, the analysis module 104 of FIG. 1 can be implemented as the example analysis module 202. As shown in FIG. 2, the analysis module 202 can include a logging module 204, a decay module 206, and a records access module 208.

The logging module 204 can determine that an occurrence has taken place. As indicated, an occurrence can be, for example, an impression or engagement by users that relates, for example, to a page of an entity on a social networking system. Occurrences can fall into various categories. Examples of categories of occurrences can include viewing, liking, commenting, posting, messaging, sharing, and accessing. Examples of categories can also include following, recommending, and checking in. In some embodiments, finer-grained categories can be used. As illustrations, there can be one category for viewing a post, and another category for viewing a search result. As further illustrations, there can be one category for liking a post, and another category for liking a page of the social networking system. Moreover, in some embodiments bot-specific categories can be used. Examples of bot-specific categories can include viewing bot-generated messages and viewing bot-generated recommendations. Examples of bot-specific categories also include messaging to a bot or otherwise interacting with bots. Bots as discussed herein can, for instance, be bots which employ machine learning-based natural language processing (NLP) or other NLP approaches. In some embodiments, an occurrence can be at least partially attributable to an action of an administrator of a page. For example, the administrator can make a post to the page. Then, for instance, an occurrence can take place when a user views the post. As another example, an administrator can advertise a page. The advertisement can lead a user to the page. Then, for instance, an occurrence can take place when the user likes the page or adds a comment to the page. Alternately or additionally, in some embodiments an occurrence can take place in absence of an action of an administrator of a page. For example, a user can perform a search. The page can be returned as a result of the search. Then, for instance, an occurrence can take place when the user shares the page. Many variations are possible.

The logging module 204 can add to a log a record which corresponds to an occurrence. The record can have multiple fields. Each of the fields can specify various types of information about the occurrence. For example, the fields can specify one or more of an entity to which the occurrence corresponds, a channel where the occurrence took place, a category of the occurrence, a user who experienced or performed the occurrence, a time when the occurrence took place, and a level for the occurrence. Many variations are possible.

The logging module 204 can choose the level for an occurrence from a set of possible levels. In some embodiments, the set can include two levels. In these embodiments, a first of the two levels can be an impression level and a second of the two levels can be an engagement level. In other embodiments, the set can include three levels. In these embodiments, a first of the three levels can be a low level, a second of the three levels can be a medium level, a third of the three levels can be a high level.

The logging module 204 can consider a category of an occurrence when choosing a level for the occurrence. For the embodiments where the set includes two levels, the logging module 204 can determine whether the category of the occurrence indicates an impression or an engagement. As known in the art, a display of information to a user without interaction of the user can indicate an impression whereas interaction of a user can indicate engagement. In some instances, the category of the occurrence can indicate the occurrence to be an impression. In these embodiments, the logging module 204 can choose the level for the occurrence to be the impression level. In other instances, the category of the event can indicate the occurrence to be an engagement. In these instances, the logging module 204 can choose the level for the occurrence to be the engagement level. For the embodiments where the set includes three levels, the logging module 204 can likewise determine whether the category of the occurrence indicates an impression or an engagement. In some instances, the category of the occurrence can indicate the occurrence to be an impression. In these instances, the logging module 204 can choose the level for the occurrence to be the low level. In other instances, the category of the occurrence can indicate the occurrence to be an engagement. In these instances, the logging module 204 can choose the level for the occurrence to be either the medium level or the high level. In particular, where the engagement directly relates to a page, the logging module 204 can choose the level for the occurrence to be the high level. Further, where the engagement does not directly relate to a page, the logging module 204 can choose the level for the occurrence to be the medium level. As an illustration, the logging module 204 can choose the level for the occurrence to be the high level where the engagement relates to liking a page. As another illustration, the logging module 204 can choose the level for the occurrence to be the medium level where the engagement involves liking a post.

The decay module 206 can access a record for an occurrence. The decay module 206 can further access a query time. The query time can be a point in time for which a user desires to receive scores and metrics. Subsequently, the decay module 206 can read a field of the record which specifies a time when the occurrence took place. The decay module 206 can then determine a time difference between the query time and the time when the occurrence took place. Further, the decay module 206 can read a field of the record which specifies a level for the occurrence. The decay module 206 can then generate a decayed level for the occurrence. The decay module 206 can generate the decayed level based on the time difference and the level specified by the record. In some embodiments, the decay module 206 can generate the decayed level using the equation:

level_{decayed}=level_{record}−Δt_{weeks}.

In the equation, level_{decayed} can be the decayed level. Also in the equation, level_{record} can be a numerical value that is associated with the level specified by the record. In embodiments where there are two possible levels, the impression level can have a corresponding numerical value of 1 and the engagement level can have a corresponding numerical value of 2. In embodiments where there are three possible levels, the high level can have a corresponding numerical value of 3, the medium level can have a corresponding numerical value of 2, and the low level can have a corresponding numerical value of 1. In the equation, Δt_{weeks} can be the time difference between the query time and the time when the occurrence took place that is rounded to the nearest number of weeks. The decay module 206 can assign a level based on a numerical value resulting from the equation. As an illustration, in embodiments where there are two possible levels and a numerical value of 1 results from the equation, the decay module 206 can consider the decayed level to be the impression level. As another illustration, in embodiments where there are three possible levels and a numerical value of 2 results from the equation, the decay module 206 can consider the decayed level to be the medium level. Where the result of the equation is a zero, the decay module 206 can determine that the record should not be considered further. In calculating a level using the equation, the decay module 206 can consider a negative result of the equation to be a zero. Many variations are possible.

After generating the decayed level, the decay module 206 can produce a decayed record. The decayed record can include the fields of the record accessed by the decay module 206. The decayed record can further include an additional field that specifies the decayed level. Where the decay module 206 has determined that the accessed record should not be considered further, the decay module 206 can use the additional field to indicate this determination. There can be many variations or other possibilities.

The records access module 208 can access an entity, a query time, a level. The level can be one of the levels discussed above (e.g., the impression level or the engagement level). The records access module 208 can retrieve from the log one or more records having fields which specify the entity. The records access module 208 can use the decay module 206 with each of the records retrieved from the log. In particular, the records access module 208 can apply the decay module 206 to the record and the query time. As a result, the decay module 206 can produce a decayed record. The decayed record can include the fields of the record retrieved from the log. The decayed record can further include a field specifying a decayed level. Subsequently, the records access module 208 can output those of the decayed records which specify decayed levels which match the level accessed by the records access module 208. In some embodiments, where the records access module 208 finds that a decayed record is marked to not be considered further, the records access module 208 does not further consider the decayed record. Many variations are possible.

FIG. 3 illustrates an example report module 302, according to an embodiment of the present disclosure. In some embodiments, the report module 106 of FIG. 1 can be implemented as the example report module 302. As shown in FIG. 3, the report module 302 can include a uniqueness module 304, a scoring module 306, a metrics module 308, and an interface module 310.

The uniqueness module 304 can access multiple decayed records. The decayed records can be produced by the decay module 206. The uniqueness module 304 can read fields of the records which specify users. Subsequently, the uniqueness module 304 can produce a value of a quantity of unique users specified among the fields of the records.

The scoring module 306 can access an entity, a query time, and one or more levels. For each of the levels, the scoring module 306 can use the records access module 208 with the entity, the query time, and a level of the one or more levels to obtain one or more decayed records. The obtained one or more decayed records can correspond to the entity, the query time, and the level.

Subsequently, for each of the levels, the scoring module 306 can produce a score. The scoring module 306 can produce the score based on the decayed records for each level and the uniqueness module 304. In particular, the score for the level can be a quantity of unique users specified by the decayed records for the level. Further, the scoring module 306 can produce a score which corresponds to all of the levels. The scoring module can produce the score based on all of the decayed records for all of the levels and the uniqueness module 304. In particular, the score which corresponds to all of the levels can be a quantity of unique users specified by the decayed records for all of the levels. In some embodiments, a score which corresponds to all of the levels can be referred to as an awareness score. As indicated, a decayed record can correspond to an occurrence. As also indicated, an occurrence can be at least partially attributable to an action of an administrator (e.g., where an administrator makes a post). As further indicated, an occurrence can take place in absence of an action of an administrator (e.g., where a user performs a search). Then, a score for a level or a score for all levels (e.g., an awareness score) can be based on decayed records. As such, under some circumstances, a score can be at least partially attributable to actions of an administrator. However, a score is not necessarily attributable to actions of an administrator. For example, a score can be at least partially attributable to actions of a user.

The metrics module 308 can access an entity, a first query time, and one or more levels. In some embodiments, the metrics module 308 can additionally access a second query time. In various embodiments, the metrics module 308 can generate one or more of a top categories metric, a fan versus not fan metric, and a new versus returning users metric. The top categories metric can provide detail relating to occurrences which contribute to a score for a level. In particular, the top categories metric can indicate which categories of those occurrences occur most frequently. The fan versus not fan metric and the new versus returning users metric can each provide detail relating to users who contributed to a score for a level. The fan versus not fan metric can indicate which of the users are fans (or followers) of an entity to which the score relates. The new versus returning users metric can provide detail relating to which of the users newly contribute to the score. In generating the metrics, the metrics module 308 can use the records access module 208 with the entity, the first query time, and the one or more levels to obtain more or more decayed records. The obtained one or more decayed records can correspond to the entity, the first query time, and the one or more levels.

To generate the top categories metric, the metrics module 308 can read the fields of the decayed records which specify categories. The metrics module 308 can then determine which t categories occur with the highest frequencies among the read fields. The value t can be a preselected value. As an illustration, t can be 1. Subsequently, the metrics module 308 can then produce the determined categories.

To generate the fan versus not fan metric, the metrics module 308 can read fields of the records which specify users. Subsequently, the metrics module 308 can determine which of these users are fans (or followers) of the entity. The metrics module 308 can also determine which of these users are not fans (not followers) of the entity. A user who is a fan of the entity can be a user who has liked (or followed) the entity through a channel. As an illustration, a user who is a fan of the entity can be a user who has liked the entity through a page of the entity on the social networking system. The metrics module 308 can subsequently produce two counts. A first of the two counts can be a count of the users determined to be fans of the entity. A second of the two counts can be a count of the users determined to not be fans of the entity.

To generate the new versus returning users metric, the metrics module 308 can further use the records access module 208. In particular, the metrics module 308 can further use the records access module 208 with the entity, the second query time, and the one or more levels to obtain one or more further decayed records. The one or more further decayed records can correspond to the entity, the second query time, and the one or more levels. The metrics module 308 can read from the obtained records which correspond to the first query time. In particular, the metrics module 308 can read from fields of these records which specify users. Further, the metrics module 308 can read from the obtained records which correspond to the second query time. In particular the metrics module 308 can read from fields of these records which specify users. The metrics module 308 can then produce a count of returning users. The count of returning users can be users specified both by the fields read from the records which correspond to the first query time and also the fields read from the records which correspond to the second query time. The metrics module 308 can then also produce a count of new users. The count of new users can be users specified only by the fields read from the records which correspond to the second query time.

The interface module 310 can receive a specification of an entity which has a presence on the social networking system. The interface module 310 can also receive specifications of one or more query times. The specifications can be provided by a user, such as an administrator of a page of the entity, and can be received through an interface provided by a user computing device. The query times can correspond to points in time for which the user desires to receive scores and metrics relating to the entity. The interface module 310 can use the scoring module 306 to generate one or more scores. In particular, the interface module 310 can use the scoring module 306 with the specification of the entity, a first of the query times, and one or more levels. The one or more levels can be levels for which scores are to be generated. As an example, the levels can be an impression level and an engagement level. In this example, a score can be generated for the impression level and a score can be generated for the engagement level. Further, in this example, in some embodiments, an awareness score can be generated.

The interface module 310 can present one or more of the scores to the user using the interface. As one example, the interface module 310 can present the scores to the user using text. As another example, the interface module 310 can present the scores to the user using a pie chart or other graphical representation of the scores. As an illustration, one slice of a pie chart can present an impression level score, one slice can present an engagement level score, and a totality of the pie can present an awareness score.

Further, the interface module 310 can use the metrics module 308 to generate one or more metrics for one or more of the scores. The interface module 310 can use the metrics module 308 multiple times. Each use can generate a metric for a given one of the scores. In particular, the interface module 310 can use the metrics module 308 with the specification of the entity, the query times, and one or more of the levels. The one or more levels can correspond to the particular score for which the metric is to be generated.

The interface module can present one or more of the metrics to the user using the interface. As one example, the metrics can be presented to the user using text. In some embodiments, the interface module 310 can receive from the user specification of the scores for which metrics are to be generated. Further, in some embodiments, the interface module 310 can receive from the user specification of the particular metrics desired. As an illustration, the user can specify that a new versus returning users metric be generated for an impression level score and for an engagement level score.

The scores and metrics can inform the user to take action which relates to the presence of the entity on the social networking system. In particular, the user can take actions with a goal of changing or improving the scores and metrics. In some embodiments, the interface module 310 can generate one or more action suggestions for the user. Subsequently, the interface module 310 can use the interface to present the action suggestions to the user. For example, the interface module 310 can generate and present a suggestion that the user make posts to a page on the social networking system which corresponds to the entry. As another example, the interface module can generate and present a suggestion that the user use the messaging functionality of a messaging service to engage with other users about the entity. There can be many variations or other possibilities.

In some embodiments, the interface module 310 can interface with a process of the social networking system which ranks items (e.g., posts) for possible inclusion in feeds of users. A rank of an item can determine whether or not the item is included in a feed of a user. A rank of an item can also influence a position at which the item is placed in a feed of a user. An item which the process is ranking can correspond to a page. The interface module 310 can provide the process with one or more scores for the page. As examples, the scores can include one or more of a score for an impression level, a score for an engagement level, and an awareness score. The scores can correspond to a query time specified by the process. The query time can be a present time. The process can use the scores as factors in the ranking. As an example, the process can use the awareness score to choose a rank for the item which is higher than a rank which the item would have received had the awareness score not be considered. For instance, the item can receive a higher rank than it would have received had ranking taken into account a number of fans which the page had, but not the awareness score.

In some embodiments, the interface module 310 can interface with a process of the social networking system which identifies pages as being trending pages. In some embodiments, the process can identify trending pages on a per-category basis. As one illustration, a category can be pages which correspond to restaurants. The process can determine a trending value for a given page. The interface module 310 can provide the process with various scores for the page. For example, the interface module 310 can provide the process with an awareness score for the page. The scores can correspond to a present time or another query time specified by the process. The process can use the scores as factors in determining the trending value for the page. In this way, the process can determine trending values for each of selected pages, such as pages which correspond to restaurants. The process can then identify one or more of the selected pages having highest trending values as being trending pages. As an example, a given page can receive a higher trending value than it would have received had the various scores (e.g., the awareness score) not been taken into account.

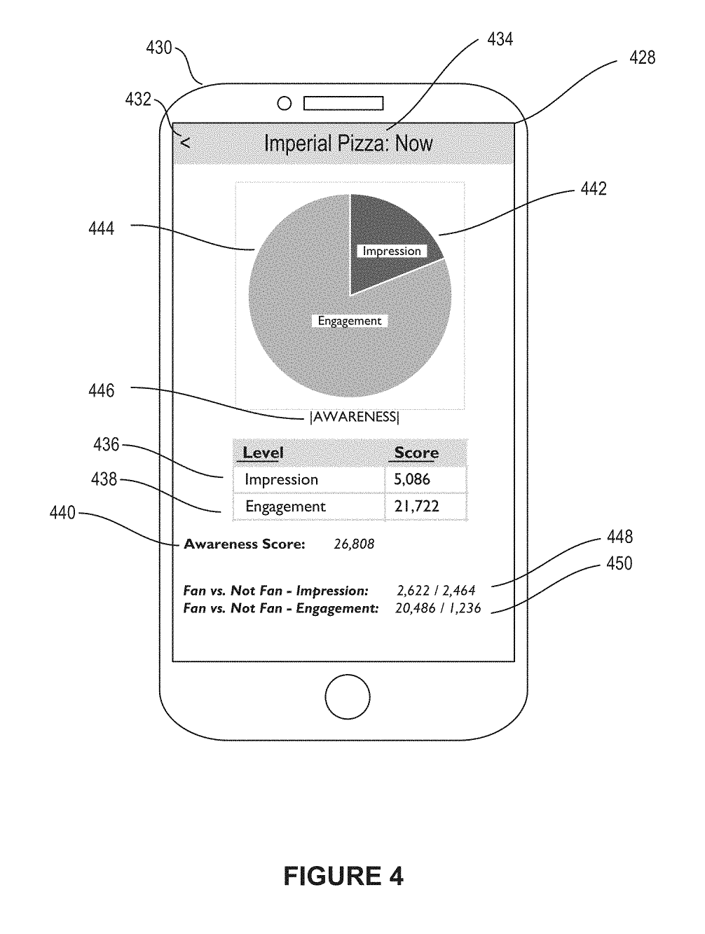

FIG. 4 illustrates an example of an interface 428, according to an embodiment of the present disclosure. The interface can be presented on the display of a computing device 430 being operated by a user. The interface 428 can be provided through an application (e.g., dedicated software application, web browser, etc.) running on the computing device 430. The user can desire to receive scores and metrics relating to an entity which has a presence on the social networking system. The user can have provided to the computing device 430 a specification of the entity. In particular, the user can have specified as the entity a restaurant named “Imperial Pizza.” “Imperial Pizza” can have a presence on a social networking system via a page and via a messaging system. The user can be an administrator for “Imperial Pizza” in connection with the page and the messaging system.

The user can also have provided to the computing device 430 a specification of a query time. The query time can be a point in time for which the user desires to receive the scores and the metrics. According to the example of FIG. 4, the user provided a present time as the query time. In some embodiments, a default query time (e.g., a present time) can be used where the user does not provide a query time. The interface 428 can provide a return element 432. By activating the return element 432, the user can change the specification of the entity and the specification of the query time. Text element 434 can state the name of the entity and the query time.

As discussed in more detail herein, the awareness module 102 can determine a score for the impression level, a score for the engagement level, and an awareness score for “Imperial Pizza” for the user-specified query time. For example, the calculation of the scores can consider instances of occurrences which relate to the page of the “Imperial Pizza” restaurant on the social networking system. As illustrations, the occurrences can include other users viewing, other users commenting, and other users sharing in connection with the page. The calculation of the scores can take into account aspects of the occurrences including categories of the occurrences and passages of time since the occurrences took place. The calculation of the scores is discussed in greater detail above. The interface 428 presents a score for an impression level to the user using text element 436 and a score for an engagement level to the user using text element 438. The interface 428 presents an awareness score to the user using text element 440. The interface 428 also provides a pie chart representation of the three scores. As shown in FIG. 4, a slice 442 of the pie chart presents the score for the impression level, and a slice 444 of the pie chart presents the score for the engagement level. Further, the interface 428 uses text element 446 to indicate that a totality of the pie chart indicates the awareness score.

The awareness module 102 can also generate various metrics for various scores. Among these metrics is, for example, a fan versus not fan metric, as discussed above. A fan versus not fan metric can indicate, for a score, how many of users having occurrences contributing to the score are fans of the entity to which the score corresponds, and how many are not. In the example of FIG. 4, the awareness module 102 determines a fan versus not fan metric for each of the impression score and the engagement score. These metrics are determined for the user-specified time of the present. In the example of FIG. 4, the interface 428 presents the determined fan versus not fan metric for the impression score using text element 448. The interface 428 presents the determined fan versus not fan metric for the engagement score using text element 450.

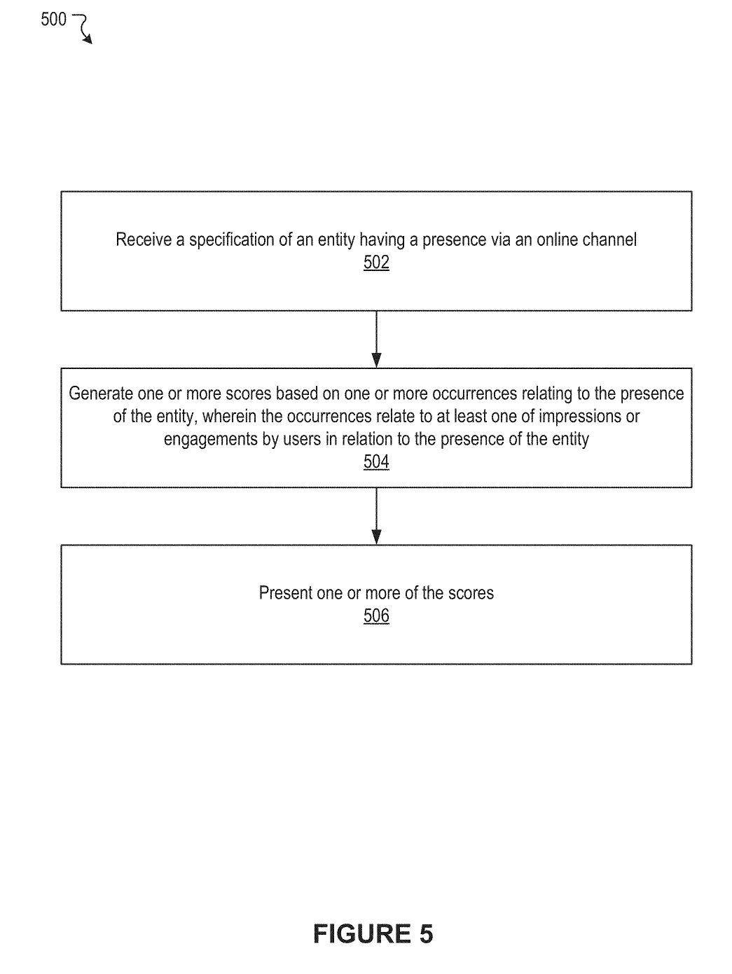

FIG. 5 illustrates an example process 500, according to various embodiments of the present disclosure. It should be appreciated that there can be additional, fewer, or alternative steps performed in similar or alternative orders, or in parallel, within the scope of the various embodiments discussed herein unless otherwise stated.

At block 502, the example process 500 can receive a specification of an entity having a presence via an online channel. At block 504, the process can generate one or more scores based on one or more occurrences relating to the presence of the entity, wherein the occurrences relate to at least one of impressions or engagements by users in relation to the presence of the entity. Then, at block 506, the process can present one or more of the scores.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), macOS, and/or a Linux distribution. In another embodiment, the user device 610 can be a computing device or a device having computer functionality, such as a smartphone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects an other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music, or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list.” External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an awareness module 646. The awareness module 646 can, for example, be implemented as the awareness module 102 of FIG. 1. In some embodiments, some or all of the functionality and modules of the awareness module 646 (e.g., sub modules of the awareness module 102) instead can be implemented in the user device 610.

### Hardware Implementation

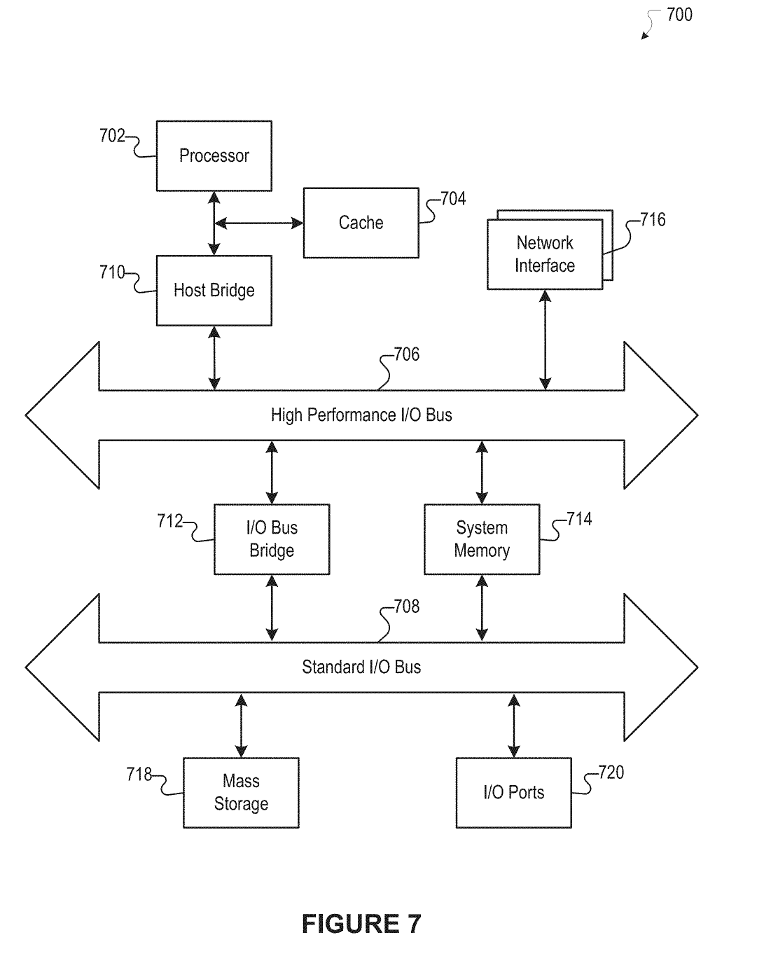

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module,” with processor 702 being referred to as the “processor core.” Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs.” For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment,” “an embodiment,” “other embodiments,” “one series of embodiments,” “some embodiments,” “various embodiments,” or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, a specification of an entity having a presence via an online channel;
generating, by the computing system, one or more scores based on one or more occurrences relating to the presence of the entity, wherein the occurrences relate to at least one of impressions or engagements by users in relation to the presence of the entity; and
presenting, by the computing system, one or more of the scores.

2. The computer-implemented method of claim 1, wherein the generating of the one or more scores is further based on a query time.

3. The computer-implemented method of claim 1, wherein the generating of the one or more scores comprises:
determining, by the computing system, one or more levels for one or more of the occurrences.

4. The computer-implemented method of claim 1, wherein the generating of the one or more scores comprises:
determining, by the computing system, one or more decayed levels for one or more of the occurrences based on a query time and on one or more times of the one or more occurrences.

5. The computer-implemented method of claim 1, wherein the one or more scores include one or more of an impression score, an engagement score, or an awareness score.

6. The computer-implemented method of claim 1, further comprising:
receiving, by the computing system, a specification of a query time.

7. The computer-implemented method of claim 1, wherein the online channel is a page on a social networking system or messaging system.

8. The computer-implemented method of claim 1, wherein the one or more occurrences are associated with one or more of viewing, liking, posting, following, or messaging.

9. The computer-implemented method of claim 1, further comprising:
generating, by the computing system, one or more metrics for one or more of the scores.

10. The computer-implemented method of claim 9, wherein the one or more metrics include one or more of a top categories metric, a fan versus not fan metric, or a new versus returning users metric.

11. A system comprising:
at least one processor; and
a memory storing instructions that, when executed by the at least one processor, cause the system to perform:
receiving a specification of an entity having a presence via an online channel;
generating one or more scores based on one or more occurrences relating to the presence of the entity, wherein the occurrences relate to at least one of impressions or engagements by users in relation to the presence of the entity; and
presenting one or more of the scores.

12. The system of claim 11, wherein the generating of the one or more scores is further based on a query time.

13. The system of claim 11, wherein the generating of the one or more scores comprises:
determining one or more levels for one or more of the occurrences.

14. The system of claim 11, wherein the generating of the one or more scores comprises:
determining one or more decayed levels for one or more of the occurrences based on a query time and on one or more times of the one or more occurrences.

15. The system of claim 11, wherein the instructions, when executed by the at least one processor, further cause the system to perform:
generating one or more metrics for one or more of the scores.

16. A non-transitory computer-readable storage medium including instructions that, when executed by at least one processor of a computing system, cause the computing system to perform a method comprising:
receiving a specification of an entity having a presence via an online channel;
generating one or more scores based on one or more occurrences relating to the presence of the entity, wherein the occurrences relate to at least one of impressions or engagements by users in relation to the presence of the entity; and
presenting one or more of the scores.

17. The non-transitory computer-readable storage medium of claim 16, wherein the generating of the one or more scores is further based on a query time.

18. The non-transitory computer-readable storage medium of claim 16, wherein the generating of the one or more scores comprises:
determining one or more levels for one or more of the occurrences.

19. The non-transitory computer-readable storage medium of claim 16, wherein the generating of the one or more scores comprises:
determining one or more decayed levels for one or more of the occurrences based on a query time and on one or more times of the one or more occurrences.

20. The non-transitory computer-readable storage medium of claim 16, wherein the instructions, when executed by the at least one processor of the computing system, further cause the computing system to perform:
generating one or more metrics for one or more of the scores.
